(19) United States
(12) Patent Application Publication
(10) Pub. No.: US 2026/0132764 A1
(43) Pub. Date: May 14, 2026

(54) Wave Energy Converter System

(71) Applicant: Concrest Energy AS, Bærums Verk (NO)

(72) Inventor: Leif Arne Tønnessen, Bærums Verk (NO)

(73) Assignee: Concrest Energy AS, Bærums Verk (NO)

(21) Appl. No.: 19/118,290

(22) PCT Filed: Oct. 9, 2023
(86) PCT No.: PCT/NO2023/060065

§ 371 Date: Apr. 3, 2025

(30) Foreign Application Priority Data
Oct. 17, 2022 (NO) 20221111

(51) Int. Cl. F03B 13/14; F03D 9/00

(52) U.S. Cl. CPC F03B 13/14; F03D 9/008; F05B 2220/706

(57) ABSTRACT

The invention provides a wave energy converter system comprising:—at least two actuators (2) comprising each a buoy (3) and a liquid pump (4) mechanically connected to the buoy (3) to be driven by the buoy movements, and—an electric generator (7) mechanically connected to an hydraulic motor (6) fluidically connected to each liquid pump (4), for converting a motion of the buoys (3) into electrical power, the wave energy converter system being characterized in that it comprises a closed liquid loop system (30) configured to fluidically connect the pumps (4) of different actuators (2) together, by passing through the hydraulic motor (6), wherein the liquid is constrained to flow from the pumps (4) through the hydraulic motor (6), and wherein the liquid is constrained to flow from the hydraulic motor (6) to the pumps (4) In particular, when a first one of the buoys (3) exerts a force on its associated liquid pump (4) that is greater than the force exerted by a second buoy (3), the liquid in the pump chamber of liquid pump (4) linked to the first buoy is directed to the pump chamber of the liquid pump (4) linked to the second buoy (3), through the closed liquid loop system (30) and the hydraulic motor (6). Thus, the liquid moves through the closed liquid loop system (30) and produces electricity via a generator (7) driven by a hydraulic motor (6) as soon as there is a difference of forces between the buoys (3) of different actuators (2). Different forces are produced when different buoys are in a different phase of a wave (9).

### FIELD OF THE INVENTION

The invention relates to a wave energy converter system.

### BACKGROUND ART

Document EP 2 411 671 discloses a floating, anchored installation for energy production, comprising an actuator with a float and a piston-type water pump which is configured to be driven by the float movements.

More precisely, the water pump has an upper chamber and a lower chamber separated by a movable piston. The piston rod is connected to the float with a rigid or flexible link and the piston is connected to a counterweight on its side opposite to that connected to the float, via a rod.

Hence, when a float is displaced upwards by a wave, water in the upper chamber is ejected from this chamber towards a turbine. Simultaneously, the lower chamber is filled with water via an inflow channel.

When the float runs down the wave, the counterweight pulls the piston downwards, whereby water is ejected from the lower chamber towards the turbine while water is refilled in the upper chamber via the inflow channel.

The turbine drives a generator which generates electricity

Document WO 2011057358 A1 discloses a non-floating, seabed mounted installation for energy production. The installation comprises one or more actuators, each consisting of a float and a piston-type liquid pump, wherein the pump is connected to the float with a flexible link allowing the float's movements to actuate the pump. The pump comprises an upper active pump chamber which is fluidically connected to an onshore located turbine mechanically connected to an electric generator.

The installation further comprises a liquid system configured to fluidically connect the at least one pump to the turbine. This liquid system includes a discharge channel that connects the discharge from the at least one pump to the inlet of the turbine, allowing the pressurized liquid to flow from the pump chamber to the turbine. Additionally, there is a return channel for sending the liquid from the outlet of the turbine back to the pump chamber.

Additionally, the liquid system includes a hydraulic control system divided into an offshore module and an onshore module, and where this hydraulic control system is composed of a set of automated valves and accumulators that regulate the pressure and flow in the various sections of the system, particularly in the high pressure and low pressure sections.

Hence, when a float is displaced upwards by a wave, the liquid in the pump connected to the float is ejected into the discharge channel of the system, charging one or more accumulators in the high-pressure section. When the pressure in accumulators reaches a predefined setpoint, the liquid is further routed towards the turbine.

The flow out of the turbine enters the low-pressure section of the system.

When a float rides down a wave, the piston of the pump connected to the float is driven downwards by the flow and pressure in the return channel of the system. The required pressure and flow are provided by accumulators and valves in the low pressure section of the system. Accumulators in the low pressure section of the system are charged with liquid either from the high pressure section or from an external pump.

All accumulators, both offshore and onshore, are charged with air or gas from an onshore source via air/gas channels.

Electricity is generated by a turbine-driven generator.

A common feature for prior art wave energy converters based on float-actuated piston pumps is that the energy for returning the pump piston to the lower position in a wave trough is provided either by an external source, such as a pump, or by utilizing potential energy captured and stored in the float's lifting sequence. While the herein first disclosed prior art stores energy by lifting a counterweight, the latter disclosed prior art stores energy by charging one or more accumulators. Other prior arts may store energy, for example, by stretching or compressing a spring.

The performance and functionality of wave converters based on float-actuated piston pumps require a fine balance between the upward stroke of the pump piston when the connected float is lifted by a wave crest and the downward stroke of the pump piston when the float is lowered in a wave trough. The stroke characteristic that provides the optimum wave power conversion varies with different wave characteristics.

A first disadvantage of the disclosed prior art installations is that when the wave characteristics differ from the ones used as basis for design, it either leads to reduced power conversion efficiency, or to maintain efficiency, it increases the cost and complexity of the installation.

For the first disclosed prior art, the pump-piston's return stroke is facilitated by a fixed counterweight, and the stroke characteristic cannot be changed for changing wave characteristics. As a result, the performance will be sub-optimal for wave characteristics that differ from the design wave.

For the second disclosed prior art, the pump stroke characteristic can be changed by regulating the air/gas charging pressure in accumulators and by controlling valves in the hydraulic system. This allows performance optimization for varying wave characteristics. However, the disadvantage is that this installation requires a complicated control system with associated hardware, ancillaries and software logics. Furthermore, an onshore located turbine will require long liquid channels with associated losses. If instead, this system should be fully marinized with turbine, control system and air/gas supply-source for accumulators moved offshore, or even subsea, the cost and availability of the installation may likely make commercialization unattractive.

A second disadvantage common for both disclosed prior art installations is that they both are both sensitive to the pump's position relative to the water surface. For example, if the position of the pump is lower (deeper) relative to water surface than designed for, the float will be lifted relative to the pump, and the piston will operate in the upper section of the pump with less available stroke-length. For the floater-mounted pump in the first disclosed prior art, the pump's position relative to the water surface varies with the floater's draught, while for the seabed-mounted pump in the second disclosed prior art, the pump's position relative to the water surface varies with tide.

A third disadvantage, particularly relevant for the second disclosed prior art where the float is free to move horizontally, is that the functioning will be impacted by wind and current, as the forces imposed by wind and current will support the pump-piston's lifting stroke, but will restrain the pump-piston's lowering stroke.

In this context, an aim of the present invention is to improve the functioning of the described prior art installations, while also enabling other advantages.

### SUMMARY OF THE INVENTION

The invention accordingly provides a wave energy converter system comprising:
at least two actuators comprising each a buoy and a liquid pump mechanically connected to the buoy to be driven by the buoy movements and having a pump chamber, and
an electric generator mechanically connected to an hydraulic motor fluidically connected to the pump chamber of each liquid pump, for converting a motion of the buoys into electrical power,
the wave energy converter system being characterized in that it comprises a closed liquid loop system configured to fluidically connect the pump chambers of different actuators together, by passing through the hydraulic motor, the closed liquid loop system comprising liquid discharge means for fluidically connecting the pump chamber of each liquid pump to an inlet of the hydraulic motor, wherein the liquid is constrained to flow from the pump chamber to the hydraulic motor, and liquid return means for connecting the pump chamber of each liquid pump to an outlet of the hydraulic motor, wherein the liquid is constrained to flow from the outlet of the hydraulic motor to the pump chamber.

In the wave energy converter system according to the invention, each buoy is a point absorber which absorbs energy from all directions through its movements at/near the water surface.

The closed liquid loop circuit allows liquid to flow from a pump chamber of one of the at least two liquid pumps, through the hydraulic motor, to the pump chamber of another of the at least two liquid pumps.

In particular, when a first one of the buoys exerts a force on its associated liquid pump that is greater than the force exerted by a second buoy, the liquid in the pump chamber linked to the first buoy is directed to the pump chamber of the liquid pump linked to the second buoy, through the closed liquid loop system and the hydraulic motor.

Thus, the liquid moves through the closed liquid loop system as soon as there is a difference of forces between the buoys of different actuators.

In other words, when the force of the buoy of an actuator produces a pressure of the liquid inside the pump chamber of that actuator that is greater than the pressure of the liquid in the discharging means of the closed loop system, the liquid is ejected from the pump chamber into the discharging means of the system.

Conversely, when the force of the buoy of an actuator produces a pressure of the liquid inside the pump chamber of this actuator that is lower than the pressure of the liquid return means of the closed loop system, the liquid flows from the return means into the pump chamber which is thus charged with liquid and made ready to eject the same liquid into the discharging means of the closed liquid loop system when the force of the corresponding buoy increases.

The hydraulic motor is hence driven by a flow of pressurized liquid arriving from the high pressure pump chambers and the liquid discharge means, while the same liquid leaves the motor at reduced pressure flowing into the liquid return means and the low pressure pump chambers.

The liquid discharge means and the liquid return means may comprise check valves for constraining the direction of liquid flow in the closed liquid loop system.

The check valves force liquid to move from the pump chamber of each actuator to the inlet of the hydraulic motor in the liquid discharge means and from the hydraulic motor outlet to the pump chambers in the liquid return means.

This prevents liquid from being discharged from the pump chamber into the return means of the system, and thus entering into the hydraulic motor through the outlet.

When the buoy exerts a force on a liquid pump, the liquid in the corresponding pump chamber is ejected under pressure to the inlet of the hydraulic motor through the common conduit and the liquid discharge means. As the hydraulic motor absorbs energy from the liquid to drive an electric generator, the liquid pressure is reduced, and hence pressure of the liquid at the outlet of the hydraulic motor is lower than its pressure at the inlet.

The liquid cannot enter the same pump chamber since the pressure of the outgoing liquid flowing through the common conduit is higher than the pressure of the liquid flowing in the other direction.

This liquid is then directed to the pump chamber of at least another liquid pump with less force exerted by its corresponding buoy, and hence has less pressure in the pump chamber and common conduit.

The liquid return means and the liquid discharge means may be fluidically connected to the pump chamber by a common duct.

The liquid discharge means and the liquid return means may comprise at least one duct provided with a check valve and another duct between this duct and the inlet, respectively the outlet, of the hydraulic motor.

The wave energy converter system may advantageously comprise several buoys.

The configuration should allow the multiple buoys to be subjected to the same wave at different times. For a fixed installation with no freedom to rotate according to wave direction, such configuration may for example be circular, star-shaped or delta-shaped. If the installation is allowed to weathervane according to the direction of the waves, the configuration may for example be V-shaped or I-shaped. The distance from the first to last buoy in the travel direction of waves should preferably be longer than the most dominant wave-length. Such configurations ensure that each actuator always has at least another actuator to interact with in an opposite phase of a wave. Continuous flow is facilitated by the multiple actuators which are sequentially actuated as the wave passes.

Alternatively, the system may be arranged with multiple buoys to be subjected to different waves at different times. Such systems may require larger distance between buoys and a higher number of buoys to increase the statistical probability that each actuator can interact with at least another actuator in an opposite phase of a wave.

According to an embodiment, each liquid pump comprises a cylinder accommodating a piston, a rod of the piston being drivably connected to the buoy of the corresponding actuator.

According to another embodiment, each liquid pump comprises a bellow having a compressible body being drivably connected to the buoy of the corresponding actuator. Unlike cylinders, bellows do not have parts that move relative to each other, and therefore requires no dynamic sealings against environment.

However, the use of cylinders with a piston may be preferred in order to achieve higher pressure differential between the inlet and the outlet of the hydraulic motor. By reducing the piston area, a certain differential force between buoys in opposite phase of a wave translates to an increased differential pressure in the closed liquid loop system. By operating with high pressure differential between inlet and outlet of the hydraulic motor, reduced liquid-flow is required for a certain power. Reduced flow allows reduced dimensions and cost of components in the flow path.

The compressible part of the bellow or the rod of the piston may be connected to the buoy by means of a flexible link, such as a wire, a chain, a hinged rod, a synthetic rope, or a combination of these.

The hydraulic motor may be a turbine, vane motor, a screw motor, or a piston motor. According to an embodiment the liquid may be a mixture of mono-ethylene glycol (MEG) and water. Such a liquid can advantageously also be used as a lubricant and cooling liquid for the hydraulic motor and electric generator.

According to another embodiment the liquid may be seawater. Seawater may be advantageous if leakage occurs as it is it easily available to refill the system.

The wave energy converter system may further comprise a floating submerged guiding platform having several guiding means each for a flexible link connecting a liquid pump to the buoy of the corresponding actuator.

The guiding platform is a stabilization device which allows to keep distance between buoys and position them according to a desired configuration.

The guiding platform also allows a compact arrangement of the submerged power fluid system, reducing pressure loss and pressure pulsations caused by acceleration and deceleration of fluid inertia.

The liquid pump, the hydraulic motor, the electric generator and the closed liquid loop system may be mounted on a support platform configured to be installed on the seabed or to float below or on the water surface.

The guiding platform or the support platform may comprise means for anchoring the platform to the seabed.

The support platform may be anchored under its own weight or otherwise secured to the seabed. For example, the support platform may be concreted to the seabed or attached to raised supports, foundations, or anchors attached to the seabed, or may be weighted down by geotextile bags or filled internal voids (e.g., with sand).

The guiding platform or the support platform may support one or more wind turbine(s).

In case the support platform is configured to float, such floater may be anchored in a fixed position or it may be allowed to weathervane by fixing the anchor link to a device on the floater that allows rotation, such as a swivel, turret or similar.

In order to improve the dynamic characteristic of the floater, and thereby also improve the power capturing from waves, heave plates may be attached to or integrated with the support platform to increase vertical drag-loss and added mass of entrained seawater.

Unlike prior art wave power systems based on point absorbers where each actuator functions independently from any other connected actuator, the invention described herein relies on the interaction between the multiple actuators where the power is generated by the force-difference exerted on the buoys in different phase of a wave, combined with the relative vertical movements of the said buoys.

The pumps attached to the buoys translates this force-difference and movement to a pressure-difference and a flow in the closed liquid loop system, constituting hydraulic power. This hydraulic power is then translated to electrical power in an electric generator driven by a hydraulic motor commonly connected to the actuators. The capability to produce differential pressure and flow for a certain wave characteristic is decided by the system layout and design of actuators, while the actual combination of differential pressure and flow in the closed liquid loop system is decided by the flow-resistance induced by the hydraulic motor. Increased flow-resistance reduces low flow and increases differential pressure while reduced flow-resistance increases flow and reduces differential pressure.

In contrast to prior art system where the piston of a pump is returned to the lower position after being lifted by a wave by means of a weight, spring, pressurized accumulator etc., the piston in the invented system is returned to the lower position because the pressure in the liquid return means exceeds the pressure in the pump chamber generated by its corresponding buoy when the force exerted on the buoy is reduced in a wave trough. Hence, the liquid in the liquid return means flows into the pump chamber and pushes down the piston, charging the pump and making it ready to discharge. Or, similarly, in case of bellow type pump, the bellow expands and charges as the liquid in the liquid return means flows into the bellow.

The system performance is purely dependent on the differential pressure generated by the buoys in different phase of the waves and is independent of the average absolute pressure in the system. This leads to numerous advantages:

Firstly, the generated power is not negatively affected by the average or static loading on the buoys caused by tidal variations (or floater-draught if liquid system with pumps is installed on a floater), wind or current.

Secondly, the system can be designed with a high averaged tension in the flexible links of the actuators, ensuring that each flexible link is under tension also when the corresponding buoy approaches the deepest wave throughs. This mitigates the problem with snapping loads in the flexible links known from prior art systems.

Thirdly, the buoys of the actuator system may in addition to harvest wave power, contribute to the buoyancy of a floater. In such an arrangement, the liquid pumps connected to the buoys will act as dampeners similar to a wheel suspension system of a car, and the dynamic properties of the floater will improve compared to conventional floaters with rigidly attached buoyancy.

Yet another important advantage with the invented system is that the system is tunable such that wave energy harvesting can be optimized for different wave characteristics. The force required to move the buoy(s) and thereby generate flow by actuating the connected pump(s) is decided by the different pressure in the discharging means versus the pressure in receiving means of the closed liquid loop system. Large wave force is required to move the buoys if the pressure difference is high, and conversely low wave force is required to move the buoys if the pressure difference is low. The actual pressure difference and the flow in the in the closed liquid loop system is decided by the hydraulic resistance of the hydraulic motor which again is decided by the load and frequency (speed) of the electric generator connected to the hydraulic motor. Hence, system can be optimized (geared) to the prevailing wave characteristics by regulating the generator's electric load and/or frequency. Possibly, the system may be self-regulating.

### BRIEF DESCRIPTION OF THE DRAWINGS

The description of the invention now continues with a detailed description of advantageous embodiments given hereinafter by way of non-limiting examples and with reference to the appended drawings, on which:

FIG. 1 is a schematic view of a wave energy converter system according to the invention;

FIG. 2 is a schematic view of a closed liquid loop system of a wave energy converter system according to the invention, fluidically connected to cylinder-piston assemblies;

FIG. 3 illustrates schematically an hydraulic circuit of a wave energy converter system according to the invention, which implements the system of FIG. 2;

FIG. 4 is a schematic top view of a guiding platform of the wave energy converter system of FIG. 1;

FIGS. 5a and 5b are respectively schematic elevation view and schematic cross-sectional view of a bellow as implemented in the wave energy converter system of FIG. 1;

FIG. 6 is a schematic elevation view of another bellow;

FIGS. 7a and 7b are respectively a schematic side cross-sectional view and schematic top view of another embodiment of a wave energy converter system according to the invention; and

FIG. 8 is a schematic perspective view of still another embodiment of a wave energy converter system according to the invention.

### DETAILED DESCRIPTION OF ILLUSTRATIVE EMBODIMENTS

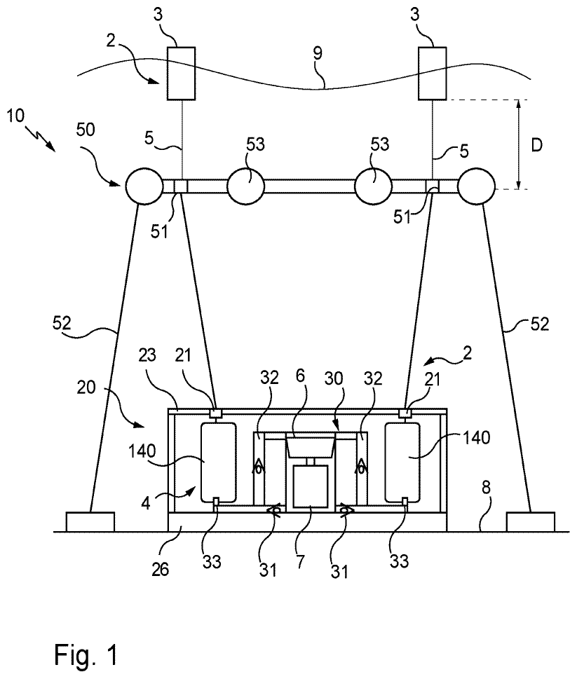

FIGS. 1 to 4 represent two different embodiments of a wave energy converter system 10, comprising several actuators 2.

As shown on FIG. 1, each actuator comprises a buoy 3, a liquid pump 4, and a flexible link 5 connecting the buoy 3 to the liquid pump 4.

The buoy 3 is intended to float on the water surface 9 while the liquid pump 4 is submerged.

The movement of the buoy 3 on the water surface 9 is thus transmitted to the corresponding liquid pump 4 via the flexible link 5.

The buoy 3 is in practice moved by the passage of a wave at the water surface 9. It has a sufficient height to avoid to be fully submerged, except of course for extreme weather conditions.

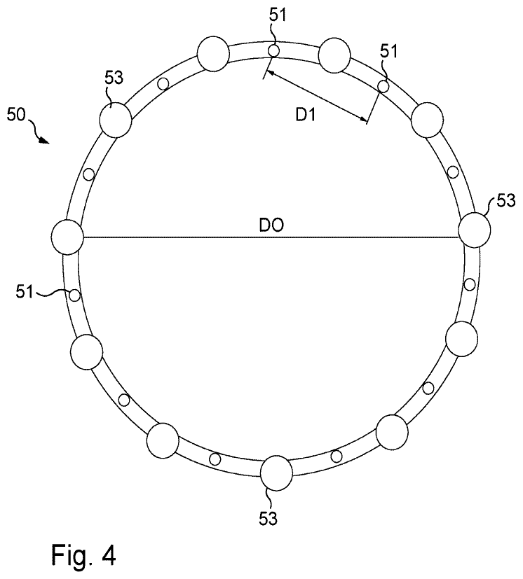

The wave energy converter system 10 also comprises here a guiding platform 50 located between the buoys 3 and the liquid pumps 4. It is anchored to the seabed 8 via cables 52 and comprises guiding holes 51 for the passage of the flexible links 5 as well as floats 53, as will be described in more details below with reference to FIG. 4.

The wave energy converter system 10 moreover comprises a support platform 20 accommodating an hydraulic motor 6 and a closed liquid loop system 30 fluidically connecting the liquid pumps 4 to the hydraulic motor 6.

The liquid pumps 4, the hydraulic motor 6, and the closed liquid loop system 30 are configured to receive a liquid.

In particular, the liquid pumps 4, the hydraulic motor 6, and the closed liquid loop system 30 are fluidically connected so that the liquid flows between these elements.

The liquid may be seawater or a liquid with lubricating and/or cooling properties, such as a mixture of mono-ethylene glycol (MEG) and water.

The hydraulic motor 6 is configured to transform hydraulic power supplied by the flowing liquid under pressure into mechanical power.

The wave energy converter system 10 also comprises in this respect an electric generator 7 mechanically connected to the hydraulic motor 6 configured to transform the mechanical power produced by the hydraulic motor 6 into electrical power. The electrical generator will be connected to an electric power transmission system which is not shown.

The wave energy converter system 10 moreover comprises a support platform 20 configured to accommodate the liquid pumps 4, the hydraulic motor 6, the electric generator 7, and the closed liquid loop system 30.

The support platform 20 is here fixed on the seabed 8.

It comprises a support structure 26 which provides a structural mounting base for the subsea equipment such as pumps 4, hydraulic motor 6, electric generator 7 and liquid loop system 30.

The support platform 20 may further comprise a frame 23 for additional horizontal support of pumps 4 and with protective sleeves 21, each for the passage of a flexible link 5.

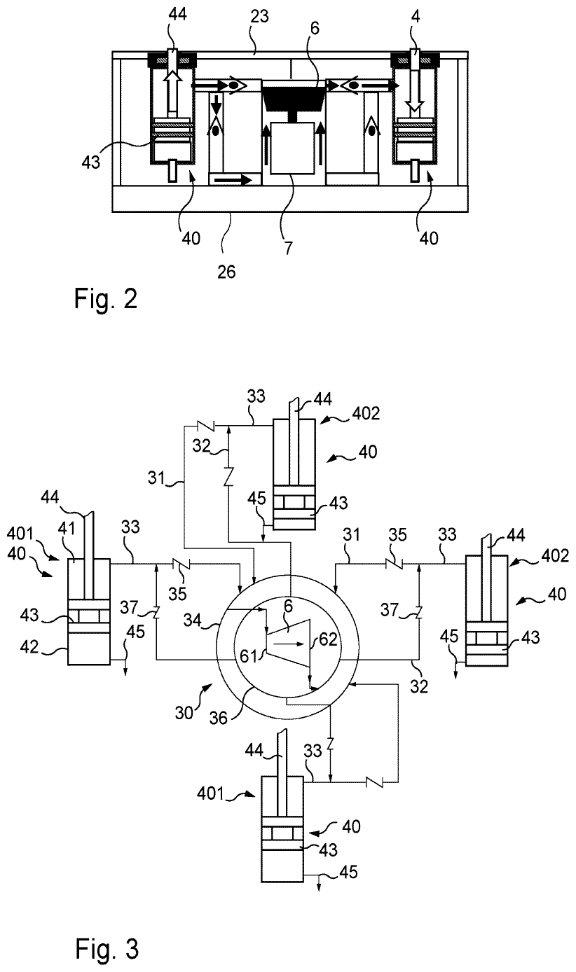

In the embodiment of FIG. 1, each liquid pump 4 comprises a bellow 140 which is drivably connected to the buoy 3 of the corresponding actuator 2 by means of a flexible link 5. Those bellows can be replaced, as shown on FIG. 2, by cylinder-piston assemblies 40, which are implemented in the closed liquid loop system shown on FIG. 3.

FIG. 3 shows in a more detailed manner the closed liquid loop system 30 of FIG. 2. As mentioned above, the liquid pumps 4 comprise here cylinder-piston assemblies 40, each of which has an upper chamber 41, a lower chamber 42, and a piston 43 that sealingly separates the upper chamber 41 from the lower chamber 42.

The piston 43 has a piston rod 44 connected to a flexible link 5 (not represented on FIG. 3). The piston 43 is thus drivably connected to the corresponding buoy 3 of an actuator 2.

The upper chamber 41 of each assembly 40 is fluidically connected to the closed liquid loop system 30.

Thus, when the buoy 3 moves upwards, for example when a wave passes, the piston 43 is pulled upwards so as to reduce the volume of the upper chamber 41.

In the example shown in FIG. 3, the system has four assemblies 40 and the upper chambers 41 are fluidically connected to each other by the closed liquid loop system 30.

The upper chamber 41 of each cylinder 40 is configured to both receive and eject pressurized liquid from/in the closed liquid loop system 30 under the effect of movements of the corresponding buoy 3.

The lower chamber 42 is here open to sea (at 45).

The closed liquid loop system 30 comprises liquid discharge means and liquid return means, and a common duct 33 that fluidically connects the liquid discharge means and the liquid return means to the upper chamber 41 of each cylinder 40.

The liquid discharge means and the liquid return means comprise respectively ducts 31 and ducts 32 configured respectively to fluidically connect each common duct 33 to an inlet 61 and an outlet 62 of the hydraulic motor 6, which is here a turbine.

Moreover, the liquid discharge means comprise a collection duct 34 mounted between the discharge ducts 31 and the inlet 61 of the hydraulic motor 6.

This collection duct 34 is configured respectively to collect liquid flowing out of the upper chambers 41 of the assemblies 40 and lead it to the inlet 61 of the hydraulic motor 6.

Conversely, the liquid return means comprise a distribution duct 36 mounted between the outlet 62 of the hydraulic motor 6 and the return ducts 32 and configured to distribute the liquid flowing out of the hydraulic motor 6 to the upper chambers 41 of the assemblies 40.

Each duct 31 comprises a first check valve 35 configured to constrain liquid to flow from the upper chamber 41 of each assemblies 40 to the inlet 61 of the hydraulic motor 6.

Each duct 32 comprise a second check valve 37 configured to constrain liquid to flow from the outlet 62 of the hydraulic motor 6 to the upper chamber 41 of each assemblies 40.

In the embodiment shown on FIG. 3, the assemblies 40 comprise cylinders referenced 401, in which the piston 43 moves upward so as to reduce the volume of the upper chamber 41, and assemblies 40 including cylinders referenced 402, in which the piston 43 moves downward so as to increase the volume of the upper chamber 41.

The piston 43 of the cylinders 401 is subjected to a force exerted by the corresponding buoy 3 via the flexible link 5, which is greater than the force exerted on the piston 43 of the cylinders 402 by the corresponding buoys 3.

The displacement of the piston 43 in the cylinders 401 under the force exerted by the buoy 3 reduces the volume of the upper chamber 41 and ejects the fluid contained therein under pressure into the fluid discharge means, which direct it towards the inlet 61 of the hydraulic motor 6.

The collection duct 34 guides in this respect the liquid flowing out under pressure from the upper chamber 41 of the cylinders 401 to the inlet 61 of the hydraulic motor 6, while the second check valves 37 prevent the liquid from passing through the liquid return means 32.

The hydraulic motor 6 then transforms the hydraulic energy of the pressurized liquid into mechanical energy and the electrical generator 7 transforms this mechanical energy into electrical energy.

At the outlet 62 of the hydraulic motor 6, the distribution duct 36 then distributes the liquid to the upper chamber 41 of the cylinders 402.

The pressure of the liquid flowing out of the upper chamber 41 of the cylinders 401 being higher than the pressure of the liquid flowing out of the hydraulic motor 6 and flowing through the liquid return means, due to the force exerted by the buoys 3 ejecting liquid from the upper chambers 41 of the cylinders 401, the latter liquid cannot enter the upper chamber 41 of the cylinders 401 through the common duct 33.

Thus, the liquid at the outlet 61 of hydraulic motor 6 is forced to enter the upper chamber 41 of cylinders for which the force exerted on piston 43 produces a lower pressure in chamber 41 than the pressure of the liquid at the outlet 61 of the hydraulic motor, i.e., cylinders 402.

This allows the upper chamber 41 of the cylinders 402 to be filled so that they are then operative to eject liquid under pressure into the liquid discharge means.

For installation in deep water and/or in case pumps 4 needs to be located in close vicinity to the hydraulic motor 6 (e.g. to reduce liquid inertia causing pressure pulsations), a guiding platform 50 as shown on FIGS. 1 and 4 will provide advantages.

The guiding platform 50 is configured for floating, here under the water surface 9, and is therefore anchored to the seabed 8.

The distance D between the guiding platform 50 and the bottom of the buoys 3 in their distal position with respect to the support platform 20 is determined at the location of installation of the system 10 so as to limit their horizontal displacement. Indeed, the smaller the distance D, the smaller the displacement of the buoy 3 with respect to the axis of its guiding hole 51.

At the same time, the guiding platform 50 maintains the buoys 3 spaced from each other so as to avoid any contact between them.

FIG. 4 shows this guiding platform 50 in isolation from a top view.

Here, the guiding platform 50 is a ring with an inner diameter D0. More precisely, the ring 50 is formed by circular arc elements fixed at their ends to the floats 53 and having each of one the guiding holes 51. The guiding holes 51 are evenly distributed along the circumference of the guiding platform 50 and alternate with the floats 53.

The circular arrangement of the guiding holes 51 allows the buoys 3 to also be arranged in a circular arrangement and thus allows the buoys 3 to be subjected to a wave at different times, and thereby facilitates force-difference between the different actuators 2 which again creates differential pressure in the closed liquid loop system 30 and establish flow through hydraulic motor 6.

At the same time, the circular arrangement of buoys makes the system performance independent of different wave directions.

The diameter D0 of the guiding platform must be larger than half a wavelength and preferably equal to or larger than one wavelength, for example 130 m.

For such a value of D0 and for a diameter of the buoys equal to 7 m, the distance D1 between two guiding holes 51 (axis to axis) is about 30 m.

In the example shown, the guiding platform 50 has eleven guiding holes 51 and eleven floats 53.

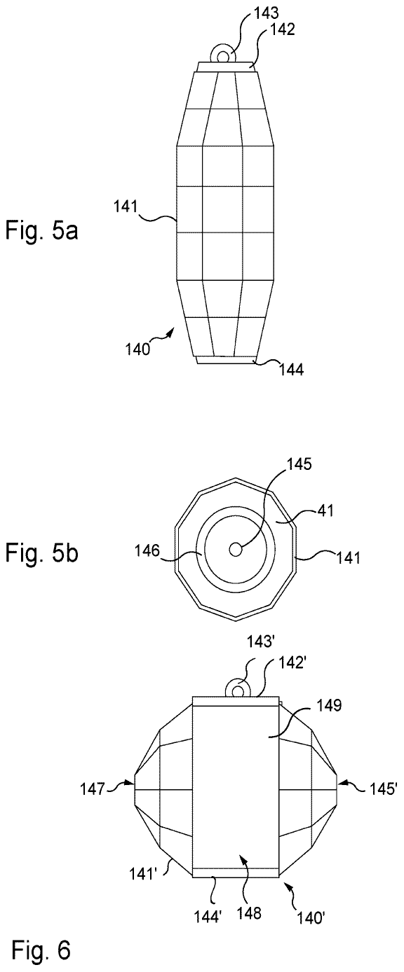

FIGS. 5a, 5b and 6 show two embodiments of a liquid pump under the form of a bellow 140.

The bellow 140 of FIGS. 5a and 5b comprises an envelope 141 having, here, an elongated ellipsoidal shape.

The upper end of the envelope 141 is closed by a disc 142 provided with a ring 143 for the fixation of a flexible link 5 to the bellow 140, and the lower longitudinal end of this envelope 141 is also provided with a disc 144, configured for fixing the bellow to the support structure 26 (not shown on the drawings) and having a central opening 145 for the connection of the bellow 140 to a common duct 33 of the closed liquid loop system 30.

The envelope is made of a high tension strength material, such as a for example fiber reinforced fabric.

This envelope wraps around a central pipe 146 fixed to the lower disc 144, in its fully stretched position.

Thanks to this pipe 146, the envelope does not completely collapse on itself when it is empty.

When the corresponding buoy 3 performs an upward movement, for example during the passage of a wave, the envelope 141 is stretched upwards reducing the diameter and thereby the inside volume of envelope 141. The liquid contained in envelope 141 is during this action ejected under pressure into the liquid discharge means 31 in order to fill the envelope 141 of other bellows 140, in the same way as for the cylinder-piston assemblies 40.

The bellows 140′ of FIG. 6 comprises a compressible body 141′ having a flattened ellipsoid shape and a compression member 142′ configured to act on the compressible body 141′.

The compressible body 141′ is intended to be fluidically connected to a common duct 33 of the closed liquid loop system 30 while the compression element 148 is intended to be drivably connected to a buoy 3 via a flexible link 5.

The compression element 148 is configured to act on the compressible body 141′ under the action of the movement of the corresponding buoy 3.

For this purpose, the compression element is 148 is fixed to the support 26 (not shown on the drawings) and is intended to transmit all the loads from flexible link 5 to support 26 such that the compressible body 141′ in this embodiment is not exposed to tension load from flexible link 5. In the example shown, the compressible body 141′ comprises an open end 145′ for connecting a duct 33 to the bellow 140′, the opposite end 147 being closed. Other positions for the connection of duct 33 to the compressible body 141′ can be considered.

The compression element 148 comprises, for its part a high tension strength fabric 149 connected by use of a transition piece 142′ to a ring 143′ for the fixation of a flexible link 5. On the opposite end is a transition piece 144′ for fixation of the high strength fabric 149 to support 26

When the corresponding buoy 3 performs an upward movement, for example during the passage of a wave, the compressible body 141′ is compressed under the action of the compression element 148 and the liquid contained therein is ejected under pressure into the liquid discharge means 31 in order to fill the compressible body 141′ of other bellows 140′, in the same way as for the cylinder-piston assemblies 40.

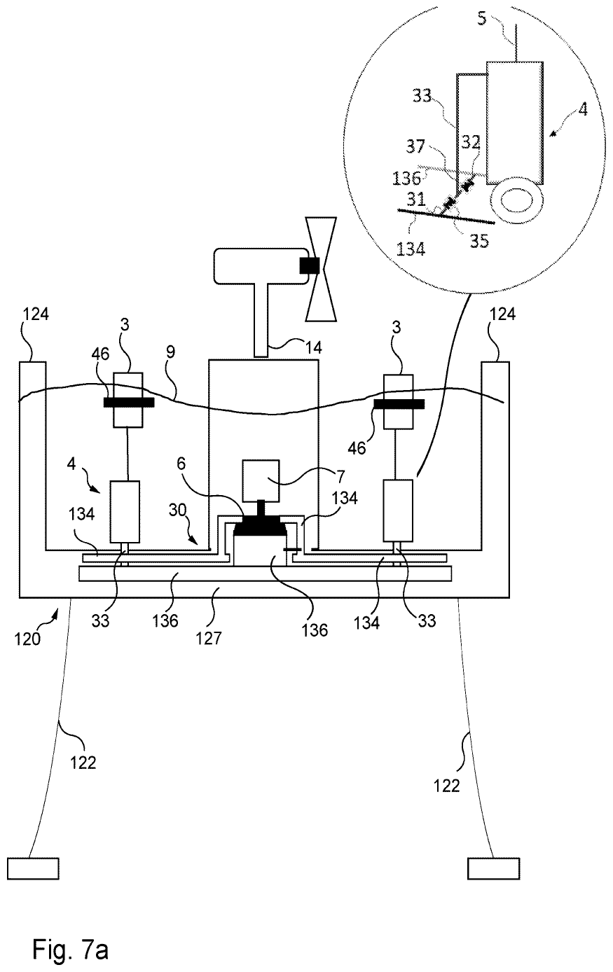

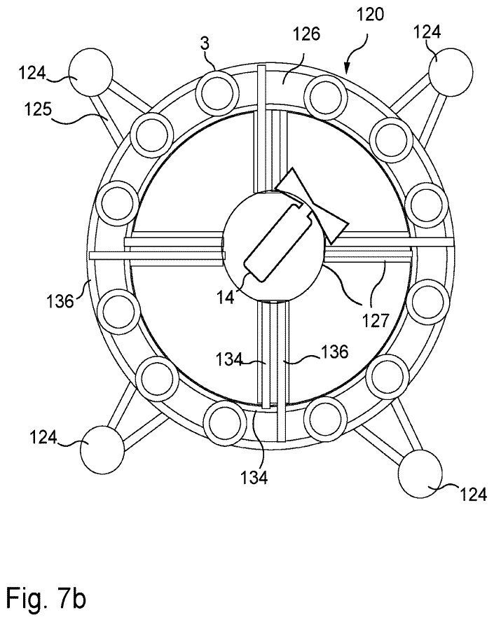

FIGS. 7a and 7b show another embodiment of the wave energy conversion system according to the present invention.

In this system, the liquid pumps 4, the closed liquid loop system 30, the hydraulic motor 6 and the electric generator 7 are installed on a floating support platform 120 comprised by a ring support 126, fixed to a cruciform inner support 127. In other words the wave energy conversion system does not comprise any guiding platform here.

The wave energy converter system may further comprise a wind turbine 14 mounted on top of the central column of inner support 127, which is housing the hydraulic motor 6 and electric generator 7. The wind turbine 14 and electric generator 7 will be connected to an electric power transmission system which is not shown in figures.

To improve its buoyancy and stability, the floating support platform 120 may also incorporate hollow columns 124 that extend vertically and emerges above the water surface.

The columns 124 are evenly distributed around the floating support platform 120 and are secured thereto with tie rods 125.

Total buoyancy for the floating support platform 120 can be provided by columns 124, buoys 3, ring support 126, and inner support 127, separately or combined.

The ducts 31 and 32 of the pump 4 liquid discharge means and liquid return means communicate with the common collection ducts 134 and the common distribution ducts 136 respectively, which are supported both by ring support 126 and inner support 127.

The liquid pumps 4 are mounted on the ring support 126 and their common ducts 33 communicate with the hydraulic motor inlet 61 and the hydraulic motor outlet 62 via respectively the collection ducts 134 and the distribution ducts 136.

The discharge flow check valves 35 and return flow check valves 37 are installed in duct 31 and 32 respectively, similar to the embodiments described above.

As can also be seen on FIG. 7, the buoys are here also provided with collars 46 for improving the effect of the waves on the buoys as these collars increase the drag force on the buoys caused by velocity of water particles in the waves.

The floating support platform 120 is anchored to the seabed 8 with cables (or chains) 122 fixed to the ring support 126 and floats under the water surface 9.

An advantageous implementation of this embodiment reducing total cost of material and improving dynamic characteristic of floating support platform 120 is to have the primary buoyancy provided by the buoys 3 and secondary buoyancy for static stability provided by columns 124. Further improved dynamic characteristic combined with enhanced capture of wave energy will be provided if ring support 126 and/or inner support 127 are/is shaped as a heave plate to increase dynamic dampening by vertical viscous drag and increase system inertia by the added mass of entrained seawater.

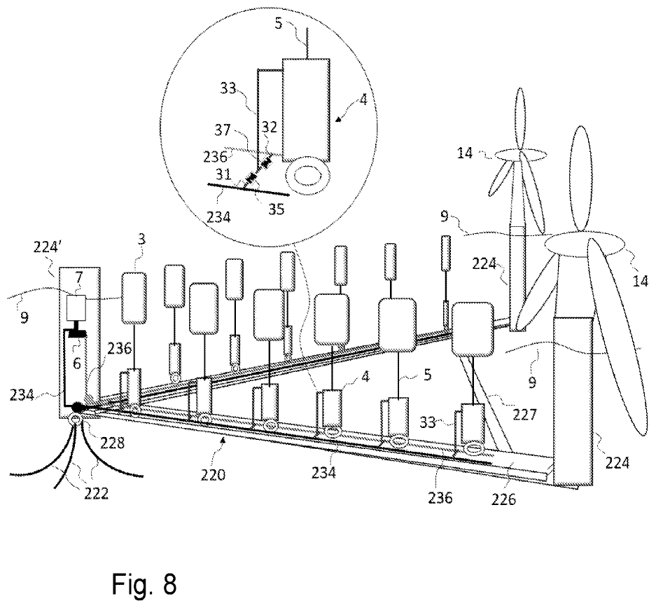

As a variant of embodiment shown on FIGS. 7a and 7b, FIG. 8 shows a layout where the circular shaped floating support platform is replaced with a delta-shaped floating support platform 220. This support platform is comprised by two linear supports 226 connected to form a V-shape, one junction beam 127 providing strength and stiffness, closing the V-shape to a Δ shape, one column 224′ in the joint of supports 226, and two columns 124 in each of the two free ends of supports 226.

Columns 224 support top-mounted wind turbines 14 and house the required equipment required for the wind turbine power transmission and any equipment needed for operating the floating support platform 220 such as e.g. ballast water pumps. This latter equipment are not shown.

Column 224′ houses hydraulic motor 6, electric generator 7 and other equipment required to operate and control the wave energy converter system and floating support platform (not shown).

The ducts 31 and 32 of the pump 4 liquid discharge means and liquid return means communicate with the common collection ducts 234 and the common distribution ducts 236 respectively, which are supported by the two linear platforms 226. The collection ducts 234 and distribution ducts 236 are again respectively connected to the hydraulic motor inlet 61 and hydraulic motor outlet 62.

The liquid pumps 4 are mounted on the two linear floating support structures 226 and their common ducts 33 communicate with the hydraulic motor inlet 61 and the hydraulic motor outlet 62 via respectively the collection ducts 234 and the distribution ducts 236.

The floating support platform 220 is anchored to the seabed 8 with cables (or chains) 222 fixed to the column 224′ and floats under the water surface 9.

A rotating link 228 provides the fixation of anchor cables 222 to the column 224′ and allows the support platform 220 to weathervane with wind and waves. The rotating link 228 may for example be a turret or an anchor swivel.

An advantageous implementation of this embodiment reducing total cost of material and improving dynamic characteristic of floating support platform 220 is to have the primary buoyancy provided by the buoys 3 and secondary buoyancy for static stability provided by columns 224 and 224′. Further improved dynamic characteristic combined with enhanced wave energy capture will be provided if platform 226 and junction beam 227 are shaped as a heave plates to increase dynamic dampening by vertical viscous drag and to increase system inertia by the added mass of entrained seawater.

Yet another advantageous implementation of this embodiment is to design and manufacture the platform 220 in sections with standard lengths with a standard number of attached actuators 2 (pump 4, link 5, buoy 3). The optimum length of the wave energy converter system may differ between projects because of different wave climate or other site-specific aspects, and by adding or removing sections, the length and capacity of the system can be configured for each project. Additionally, cost-reduction in engineering, transportation and manufacturing can be achieved by building the system in standardized sections. By assembling the wave converter system in the sea by means of connecting pre-fabricated sections, the size of the wave converter system is made independent of the size of the manufacturing site, for example drydock.

Elements described in the embodiments shown in FIGS. 7 and 8 may be combined with elements of the embodiments described with reference to FIGS. 1 to 6.

In particular, the embodiments described with reference to FIGS. 1 to 4 may comprise a guiding platform with columns and/or with a central support bearing a wind turbine, for example.

Variants and embodiments that are not illustrated are also described below.

The wave energy converter system may comprise more or less actuators 2 than in the embodiments described above.

In case liquid pumps 4 comprise cylinder-piston assemblies 40 with dynamic seals, liquid leakage may occur. Any leaked liquid must be replaced, either by pumping directly from the sea or, if liquid is not seawater, from a liquid storage tank. If the liquid in the closed liquid loop system 30 is not seawater, it may be advantageous to collect the leaked liquid in order to pump it back into the system. For example, the lower chamber 42 of pumps 4 can be connected (at 45) to a drain collection system in order to collect any leakage from chamber 41 across piston 43. This drain collection system may be common for all cylinders 40 such that leaked liquid from all cylinders are collected in a common tank. This drain collection system (including lower chambers 42), may be filled with gas, for example air or nitrogen, typically at atmospheric pressure or pressure equal to surrounding seawater.

Other shapes of the floating platform and guiding platform can be considered, such as linear, rectangular, star shaped, Y-shaped, X-shaped, U-shaped or S-shaped.

The floating platforms may integrate no wind turbine, one wind turbine or more wind turbines. The fixation method of wind turbine may vary and is not limited to the examples described and represented.

Further, the floating platforms may incorporate a controllable ballasting system to ease installation and maintenance, and also to improve survivability in rough weather conditions, potentially without halting power production.

1-22. (canceled)

23. A wave energy converter system comprising:
at least two actuators comprising each a buoy and a liquid pump mechanically connected to the buoy to be driven by the buoy movements and having a pump chamber;
an electric generator mechanically connected to an hydraulic motor fluidically connected to the pump chamber of each liquid pump, for converting a motion of the buoys into electrical power;
a closed liquid loop system configured to fluidically connect the pump chambers of different actuators together, by passing through the hydraulic motor, the closed liquid loop system comprising liquid discharge means for fluidically connecting the pump chamber of each liquid pump to an inlet of the hydraulic motor;
wherein the liquid is constrained to flow from the pump chamber to the hydraulic motor, and liquid return means for connecting the pump chamber of each liquid pump to an outlet of the hydraulic motor; and
wherein the liquid is constrained to flow from the outlet of the hydraulic motor to the pump chamber, wherein the at least two actuators are spaced with respect to the direction of wave propagation such that each buoy of an actuator is in a different phase of a wave than the at least another buoy of another actuator at a given time, and thereby exposed to different wave forces, such that the at least one actuator with higher force from its buoy discharges liquid flow from its pump chamber as the buoy is lifted, and this flow is then constrained to flow through the hydraulic motor and into the pump chamber of the at least another actuator with lower force from its buoy and thereby charging the pump chamber of this at least another actuator with liquid making it ready to discharge.

24. The wave energy converter system according to claim 23, wherein ducts of the liquid discharge means and the liquid return means comprise check valves for constraining the direction of liquid flow in the closed liquid loop system.

25. The wave energy converter system according to claim 23, wherein the liquid discharge means and the liquid return means are fluidically connected to the pump chamber by a common duct.

26. The wave energy converter system according to claim 23, wherein the liquid discharge means comprises at least a liquid discharge duct and a liquid collection duct collecting liquid from discharge ducts of pumps and route to inlet of hydraulic motor, and wherein the liquid return means comprises at least a liquid return duct and a liquid distribution duct to distribute liquid from outlet of hydraulic motor to liquid return ducts of pumps.

27. The wave energy converter system according to claim 23, comprising several buoys arranged according to a ring configuration, V-configuration, Δ(delta)-configuration, I-configuration or * (star)-configuration.

28. The wave energy converter system according to claim 23, wherein the liquid pump comprises a bellow having a compressible body being drivably connected to the buoy of the corresponding actuator.

29. The wave energy converter system according to claim 23, wherein the liquid pump comprises a cylinder accommodating a piston, a rod of the piston being drivably connected to the buoy of the corresponding actuator.

30. The wave energy converter system according to claim 28, wherein the compressible part of the bellow, or the rod of the piston is connected to the buoy by means of a flexible link, such as a wire, chain, a hinged rod, a synthetic rope, or a combination of these.

31. The wave energy converter system according to claim 23, wherein the hydraulic motor is a turbine, a vane motor, a screw motor or a piston motor.

32. The wave energy converter system according to claim 24, wherein said liquid is a mixture of mono-ethylene glycol (MEG) and water.

33. The wave energy converter system according to claim 23, wherein said liquid is seawater.

34. The wave energy converter system according to claim 23, wherein the liquid pump, the hydraulic motor, the electric generator and the closed liquid loop system are configured to be installed on the seabed, supported by at least one support platform.

35. The wave energy converter system according to claim 23, further comprises a guiding platform having several guiding means, each for a flexible link connecting a liquid pump to the buoy of the corresponding actuator, and where the guiding means could be a hole, a slot or a ring flexibly or rigidly connected to the guiding platform.

36. The wave energy converter system according to claim 35, wherein the guiding platform is configured to float below the water surface.

37. The wave energy converter system according to claim 35, wherein the guiding means are arranged in a ring configuration on the guiding platform.

38. The wave energy converter system according to claim 23, wherein the liquid pump, the hydraulic motor, the electric generator and the closed liquid loop system are configured to be installed on a floating platform.

39. The wave energy converter system according to claim 38, wherein a support platform is configured to float by utilizing the buoyancy of the buoys alone or in combination with other buoyant parts of platform such as columns and/or support structure.

40. The wave energy converter system according to claim 38, wherein a floating support platform utilize heave plates for increased vertical resistance and added mass of entrained water, and wherein the heave plates are attached to support structure, or the support structure in itself is designed to function as a heave plate due to an extended horizontal footprint.

41. The wave energy converter system according to claim 38, wherein the floating support platform comprises a rotating link, for example a turret or a swivel, fixed to the anchoring system allowing the platform to rotate in the direction of with wind or waves.

42. The wave energy converter system according to claim 38, wherein the draught and mass of the floating platform can be regulated by means of controllable ballasting system.

43. The wave energy converter system according to claim 35, wherein the guiding platform or the support platform comprises means for anchoring the platform to the seabed.

44. The wave energy converter system according to claim 35, wherein the guiding platform or the support platform supports at least one wind turbine.
